(19) United States
(12) Patent Application Publication
(10) Pub. No.: US 2007/0208784 A1
(43) Pub. Date: Sep. 6, 2007

(54) Parsing computer system logging information collected by common logging

(76) Inventors: Ralph Thomas Beeston, Tucson, AZ (US); Thomas William Bish, Tucson, AZ (US); Henry Zheng Liu, Tucson, AZ (US); Daniel James Winarski, Tucson, AZ (US)

Correspondence Address: JOHN H. HOLCOMBE;IBM CORPORATION, IP LAW DEPT., 8987 E. TANQUE VERDE RD., #309-374, TUCSON, AZ, 85749, US

(21) Appl. No.: 11/367,666

(22) Filed: Mar. 3, 2006

(51) Int. Cl. G06F 17/30

(52) U.S. Cl. 707/203

(57) ABSTRACT

Computer systems, logging daemons, methods, and computer program products are provided for logging information from a plurality of logging applications regarding the computer system. A registry is configured to identify the logging applications, and the plurality of logging applications are configured to identify the logged information in accordance with a common protocol and in accordance with the registry. A logging control is configured to parse the logged information, and configured to save the logged information in accordance with the parsing.

### FIELD OF THE INVENTION

This invention relates to logging of information related to computer systems, and, more particularly, to multiple logging applications for the computer system.

### BACKGROUND OF THE INVENTION

Saving execution logs of applications in a computer system is a reliable way of understanding the system's running history, to analyze system performance, to diagnose the system's fault symptoms, etc. When a problem occurs in a system, the logged data can be analyzed to determine what the problem is, to determine what the cause was, and to provide a fix for the problem. The logged data can be a tool to minimize a system's outages caused by certain failures. The logged data can also be a tool for application developers to debug products in order to deliver better products. Logging methods are at the cost of system resources that otherwise would be used by the system.

### SUMMARY OF THE INVENTION

Computer systems, logging daemons, methods, and computer program products are provided for logging information from a plurality of logging applications regarding the computer system. In an embodiment of the invention, a registry is configured to identify the logging applications, and the plurality of logging applications are configured to identify the logged information in accordance with a common protocol and in accordance with the registry. A logging control is configured to parse the logged information, and configured to save the logged information in accordance with the parsing.

In a further embodiment of the invention, the registry is configured to be updateable in accordance with logging applications.

In another embodiment of the invention, the logging daemon is configured to parse the logged information in accordance with a plurality of logging applications.

In a further embodiment of the invention, the logging daemon is configured to share at least a portion of the saved logged information among at least a portion of the plurality of logging applications.

In still another embodiment of the invention, error resource allocation capability is configured to, as the result of detection of a logging error, allocate new space for saving the logged information.

For a fuller understanding of the present invention, reference should be made to the following detailed description taken in conjunction with the accompanying drawings.

### BRIEF DESCRIPTION OF THE DRAWINGS

FIG. 1 is a diagrammatic illustration of an embodiment of a computer system and logging data flow implementing the present invention;

FIG. 2 is a diagrammatic illustration of the computer system and logging data flow of FIG. 1, in an embodiment illustrating space sharing;

FIG. 3 is a diagrammatic illustration of the computer system and logging data flow of FIG. 1, in an embodiment illustrating recovery of logging data flow;

FIG. 4 is a flow chart depicting an embodiment of the registry of the computer system and logging data flow of FIG. 1;

FIG. 5 is a flow chart depicting an embodiment of the computer system and logging data flow space sharing of FIG. 2;

FIG. 6 is a flow chart depicting an embodiment of the computer system and logging data flow recovery operations of FIG. 3; and

FIG. 7 is a flow chart depicting an embodiment of the computer system and logging data flow recovery operations of FIG. 3.

### DETAILED DESCRIPTION OF THE INVENTION

This invention is described in preferred embodiments in the following description with reference to the Figures, in which like numbers represent the same or similar elements. While this invention is described in terms of the best mode for achieving this invention's objectives, it will be appreciated by those skilled in the art that variations may be accomplished in view of these teachings without deviating from the spirit or scope of the invention.

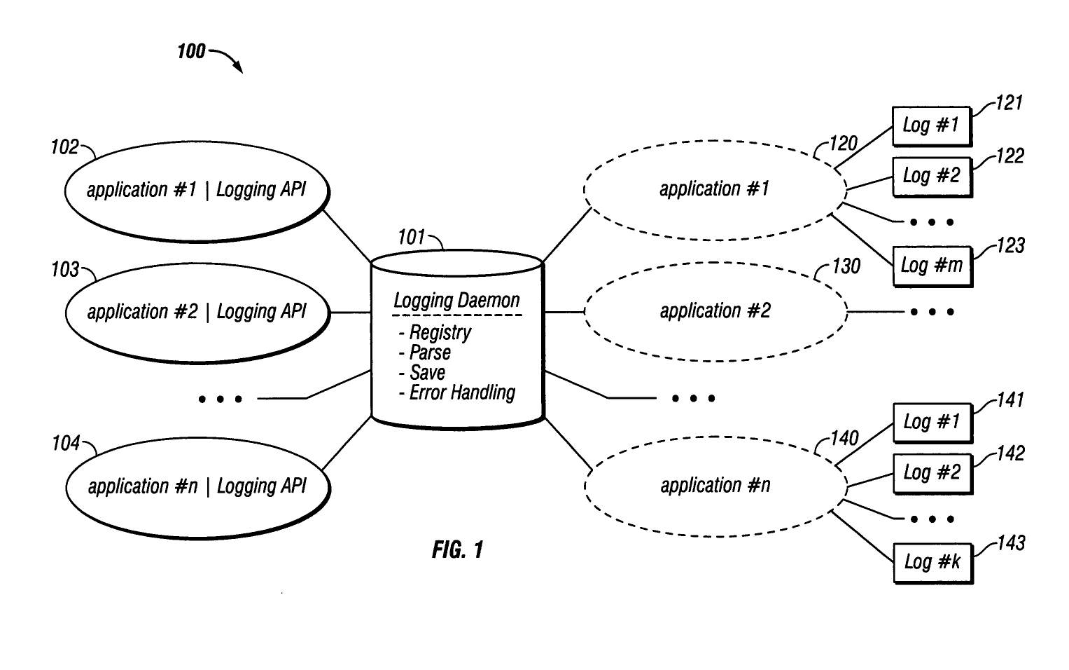

Referring to FIG. 1, a computer system 100 may comprise any computer system or subsystem of at least one programmable computer processor which runs one or more applications, where traces, events, errors, etc., of the application(s) are logged. The computer system 100 may comprise a single programmable computer processor and attached or networked systems, may comprise a network of associated programmable computer processors and attached or networked systems, or may comprise a subsystem that may form part of another system, all as known to those of skill in the art. One example of a computer system 100 comprises a virtual tape server having one or more programmable computer processors and associated magnetic tape library systems, such as a magnetic tape library and a number of magnetic tape data storage drives. Another example of a computer system 100 comprises a virtual optical server having one or more programmable computer processors and associated optical disk library and a number of optical data storage drives. In this regard, optical includes CD (Compact Disk), DVD (Digital Versatile Disk), HD-DVD (High Definition DVD), Blu-Ray, and holography disks and drives. Yet another example of a computer system 100 comprises a virtual tape server having one or more programmable computer processors and associated hard disk drive arrays which emulate magnetic tape library systems.

A plurality of logging applications 102, 103, 104, as are known in the prior art, are configured to log information regarding the computer system 100, such as traces, events, errors, etc., regarding the operation of the computer system or of applications of the computer system. The logging applications 102, 103, 104, may comprise stand-alone logging applications or may comprise other applications that also conduct logging. In accordance with an embodiment of the present invention, a logging daemon 101 provides a common logging method for the logging applications 102, 103, 104, to log the information, providing single threaded “many-to-many” management. The logging daemon may comprise an application of the computer system 100, may comprise a separate logging server, or may comprise a part of one or more of the logging applications.

The logging daemon 101 is configured to provide a registry and a logging control, the logging control configured to parse the logged information in accordance with the logging applications, and configured to save the logged information in accordance with the parsing. Additionally, an error handling facility handles errors to or of the logging applications, and provides an error resource allocation capability configured to, as the result of detection of a logging error, allocate new space for saving said logged information.

The registry of the logging daemon 101 provides a registry for each of the logging applications, which specifies a separate identifier for each of the logging applications. The logging applications 102, 103, 104, may log their data through common API (Application Program Interface) calls, and also configure their own logging criterion in advance or dynamically. The present invention allows a few more bytes of data to be attached to the original logging data string to specify the application's registry identifier and logging criterion.

Referring to FIG. 4, in step 404, logging data is received from a logging application 402. In step 406, the logging daemon logging control determines whether the data package is valid, which may mean whether the data package is identified in accordance with the common logging format. If not, the data package is considered “junk” and sent to a junk data manager 408 and abandoned, etc.

In step 410, a determination is made whether the data package has an identification that is registered in the registry. If not, the data package may represent a dynamic change to an existing logging application, and the identifier is obtained from the registry in step 412. Further, the data package may represent a new category to which the data is to be saved, as determined in step 414, and a new resource is allocated in step 418, and the data is parsed and routed to the proper log(s). A good data package is routed immediately to its resource destination in step 416.

Referring to FIG. 6, a new communication signal may be received from an application. This may comprise a new application or a reactivated failed or terminated application in step 602. The logging daemon establishes the communication between the application and itself optimally as soon as the first signal is sent to it by the application in step 604. Step 606 determines whether a previously registered identification exists, and, if so, the registry tables are updated in step 610, and, if not, the application is registered in step 608. Step 612 returns to step 412 of FIG. 4 to normalize the application's logging data flow and route the data string to the proper data space. Alternatively, the server providing the logging daemon may fail or be terminated, while applications may still be active during the absence of the logging server. When a failed or terminated server is back alive again, it will rebuild its application registry table entry as soon as the application's logging signal is received, for example, as in steps 602-612.

An example of the data flow is represented in FIG. 1, in which the logging daemon 101 logging control parses the incoming data packages from applications 120, 130 and 140 to the resource destinations dictated by the respective logging applications, and saves the data packages to the respective logs. For example, application #1 120 may indicate that the data packages are to be parsed to logs 121 and 122-123, while application #n 140 may indicate that the data packages are to be parsed to logs 141 and 142-143. Thus, the logging control parses the logged information in accordance with a plurality of logging applications. Examples of logged information comprise trace logs which log information relating to “what is the device or an application doing?”, such as mounting data storage cartridge #xxxxx to drive #xxx, sending data, etc.; event logs which log specific events, such as upgrading the microcode of a drive at time xxxx, etc.; and error logs which identify error indications (soft or hard), etc.

The logging daemon parses the logged information into specific categories, which may comprise specific events, traces or errors, or combinations of events and errors, or combinations of traces and errors, or combinations of traces and events, or combinations of all three.

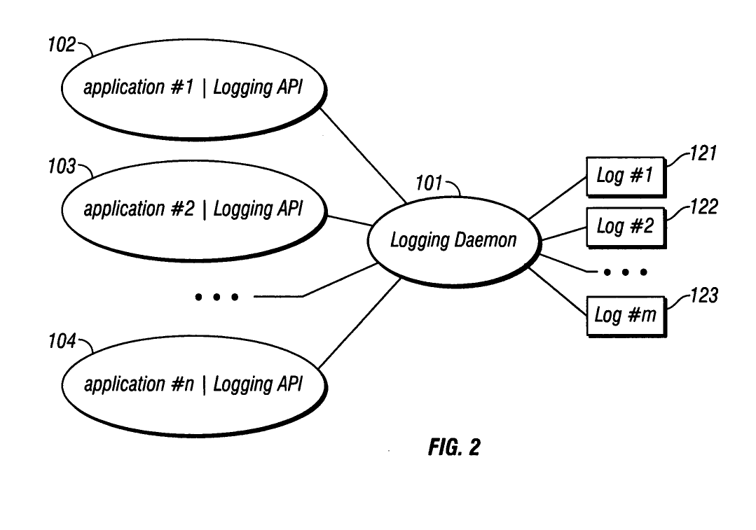

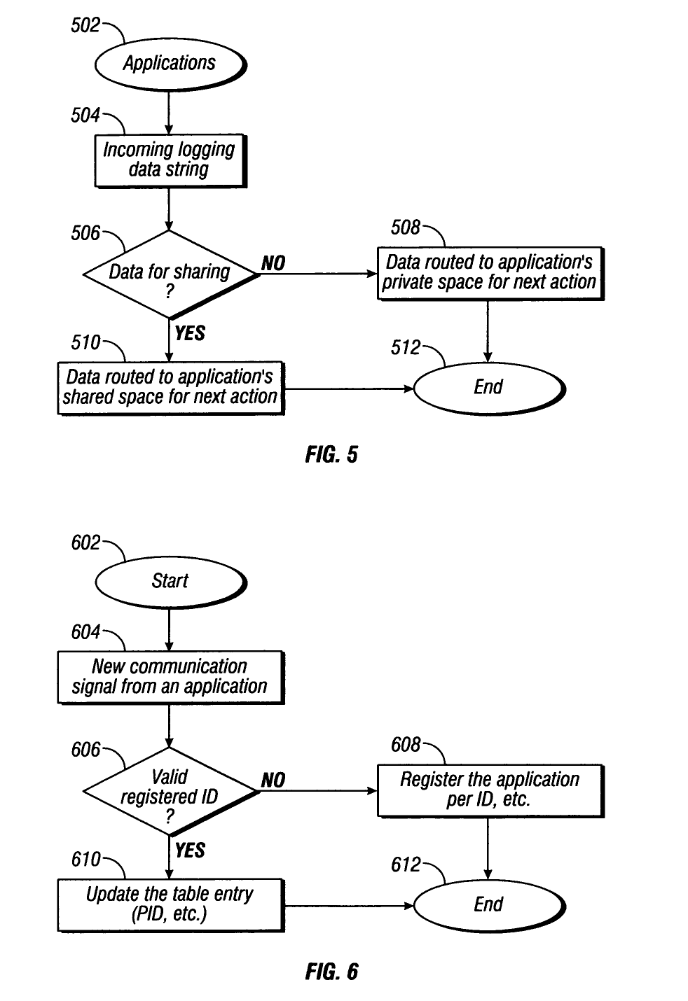

Alternatively, some of the logs may be shared in the same data space. Referring to FIGS. 2 and 5, the logging control is configured to share at least a portion of the saved logged information among at least a portion of the plurality of logging applications. In step 504, logging data is received from a logging application 502. In step 506, the logging daemon logging control determines whether the data is to be shared, and, if not the data is routed to the application's private space, such as the logs of FIG. 1, discussed above, in step 508. If the logging daemon logging control determines that the data is to be shared, in step 510, the data is parsed as needed and routed to the application's shared space for the next action. An example of the data flow is represented in FIG. 2, in which the logging daemon 101 logging control parses the incoming data packages to the shared resource destinations dictated by the respective logging applications, and saves the data packages to the respective logs. For example, application #1 and application #2 may indicate that the data packages are to be parsed to shared logs 121 and 122-123. Thus, the logging control parses the logged information in accordance with a plurality of logging applications.

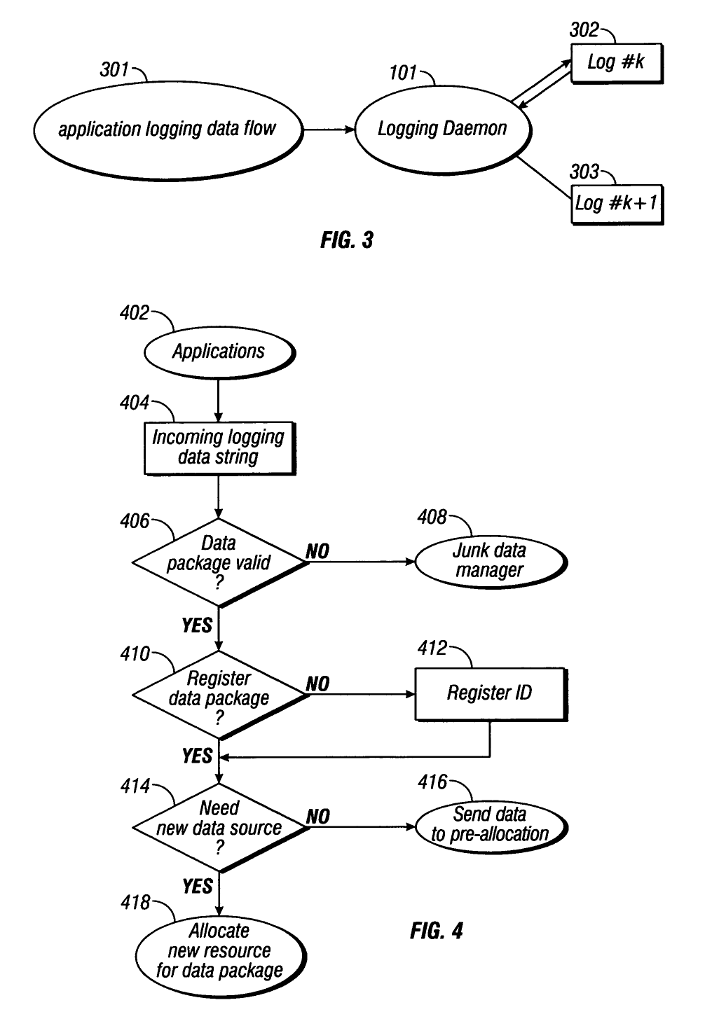

In addition to the identifier, the registry may maintain the identification of shared resources and the message queues for the daemon to parse and save the data of the application. Thus, referring to FIGS. 3 and 4, if an application dies, the logging daemon 101, in steps 410-416, automatically re-establishes the shared memory and message queue already in the registry, and re-establishes the data flow from the application 301 to the application log(s) 302 and 303.

As discussed above, the server providing the logging daemon may fail or be terminated, while applications may still be active during the absence of the logging server. Further, an application's logging data space may be destroyed (used by another program) while both the logging daemon and the application are still normally active. Such an abnormal action may be unknown to the application itself, which continues to send its logging data string(s) to the logging daemon.

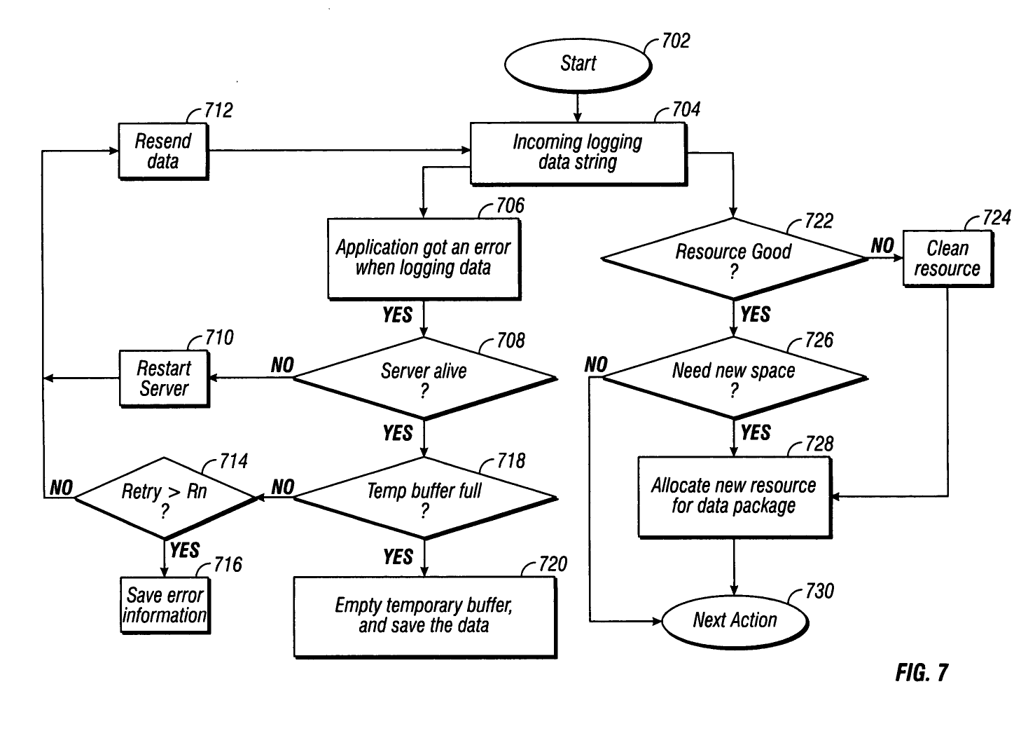

Referring to FIGS. 3 and 7, an incoming logging data string 704 is received from a logging application 702, and if there is an error in attempting to log the data (step 706), step 708 determines whether the server is alive, and, if not, the server is restarted (probably when the computer system or daemon are restarted) in step 710, and the data is resent in step 712. Further, the application registry table entries will be rebuilt, treating the present data as new data as discussed above with respect to FIG. 6. If the temporary buffer is full (step 718), in step 720, the temporary buffer is emptied and the data saved. If neither of these problems caused the problem, retries may be conducted in step 714, and error information is saved in step 716.

Step 722 determines whether the resource to which the logged data is saved is good, and, if not, the resource 302 is cleaned in step 724, and a new resource 303 is allocated in step 728. Step 726 determines if new space is required, and, if so, added resources 303 are allocated in step 728, and the next action is taken in step 730.

Those of skill in the art will understand that changes may be made with respect to the data flow of FIGS. 1, 2 and 3, and that steps may be reordered and other changes made to the flow diagrams of FIGS. 4, 5, 6 and 7. Further, those of skill in the art will understand that differing specific component arrangements may be employed than those discussed herein.

While the preferred embodiments of the present invention have been illustrated in detail, it should be apparent that modifications and adaptations to those embodiments might occur to one skilled in the art without departing from the scope of the present invention as set forth in the following claims.

What is claimed is:

1. A computer system comprising:
a registry configured to identify logging applications;
a plurality of logging applications, each configured to log information regarding said computer system, and configured to identify said logged information in accordance with a common protocol and in accordance with said registry; and
a logging control configured to parse said logged information, and configured to save said logged information in accordance with said parsing.

2. The computer system of claim 1, wherein said registry is configured to be updated in accordance with logging applications.

3. The computer system of claim 1, wherein said logging control is configured to parse said logged information in accordance with a plurality of logging applications.

4. The computer system of claim 3, wherein said logging control is configured to share at least a portion of said saved logged information among at least a portion of said plurality of logging applications.

5. The computer system of claim 1, additionally comprising error resource allocation capability configured to, as the result of detection of a logging error, allocate new space for saving said logged information.

6. A logging daemon configured to log information from a plurality of logging applications, each configured to log information regarding a computer system, comprising:
a registry configured to identify logging applications, whereby said plurality of logging applications may identify said logged information in accordance with a common protocol and in accordance with said registry; and
a logging control configured to parse said logged information, and configured to save said logged information in accordance with said parsing.

7. The logging daemon of claim 6, wherein said registry is configured to be updated in accordance with logging applications.

8. The logging daemon of claim 6, wherein said logging control is configured to parse said logged information in accordance with a plurality of logging applications.

9. The logging daemon of claim 8, wherein said logging control is configured to share at least a portion of said saved logged information among at least a portion of said plurality of logging applications.

10. The logging daemon of claim 6, additionally comprising error resource allocation capability configured to, as the result of detection of a logging error, allocate new space for saving said logged information.

11. A method for logging information from a plurality of logging applications, each configured to log information regarding a computer system, comprising the steps of:
providing a registry configured to identify logging applications, whereby said plurality of logging applications may identify said logged information in accordance with a common protocol and in accordance with said registry;
parsing said logged information; and
saving said logged information in accordance with said parsing.

12. The method of claim 11, wherein said step of providing said registry additionally comprises updating said registry in accordance with logging applications.

13. The method of claim 11, wherein said step of parsing said logged information is conducted in accordance with a plurality of logging applications.

14. The method of claim 13, wherein said step of saving said logged information additionally comprises sharing at least a portion of said saved logged information among at least a portion of said plurality of logging applications.

15. The method of claim 11, additionally comprising the step of, as the result of detection of a logging error, allocating new space for saving said logged information.

16. A computer program product embodied on at least one computer readable medium, configured to be usable with at least one programmable computer processor to log information from a plurality of logging applications, each configured to log information regarding a computer system, comprising:
computer readable program code causing said at least one programmable computer to provide a registry configured to identify logging applications, whereby said plurality of logging applications may identify said logged information in accordance with a common protocol and in accordance with said registry;
computer readable program code causing said at least one programmable computer to parse said logged information; and
computer readable program code causing said at least one programmable computer to save said logged information in accordance with said parsing.

17. The computer program product of claim 16, wherein said computer readable program code causes said at least one programmable computer to provide said registry additionally causes said at least one programmable computer to update said registry in accordance with logging applications.

18. The computer program product of claim 16, wherein said computer readable program code causes said at least one programmable computer to parse said logged information in accordance with a plurality of logging applications.

19. The computer program product of claim 18, wherein said computer readable program code causes said at least one programmable computer to share at least a portion of said saved logged information among at least a portion of said plurality of logging applications.

20. The computer program product of claim 16, wherein said computer readable program code causes said at least one programmable computer to, as the result of detection of a logging error, allocate new space for saving said logged information.
